(19) United States
(12) Patent Application Publication
(10) Pub. No.: US 2011/0019211 A1
(43) Pub. Date: Jan. 27, 2011

(54) SYSTEM AND METHOD FOR ALTERING DOCUMENT OUTPUT PROPERTIES IN ACCORDANCE WITH ALTERING INTERCEPTED PRINT STREAM DATA

(76) Inventors: Dinraj Ramachandran NAIR, Kochi (IN); Jianxin Wang, Trabuco Canyon, CA (US); Giri Natarajan, La Palma, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/506,505

(22) Filed: Jul. 21, 2009

(51) Int. Cl. G06F 15/00

(52) U.S. Cl. 358/1.9

(57) ABSTRACT

The subject application is directed to a system and method altering document output properties in accordance with altering intercepted print stream data. Print stream data is received from an associated data processing device, with the print stream including data corresponding to at least one electronic document and associated processing instruction data. Data representing a preselected data string is stored in a data storage, with the data string corresponding to a document processing command. The data string is stored associatively with secondary document processing instruction data. The received print stream data is compared to the preselected data string, and a coincidence between the print stream data and the preselected data string is detected from the comparison. The secondary document processing operation is inserted into the print stream based upon a detected coincidence. A document processing operation is completed on the document inclusive of the secondary document processing operation in accordance with an inserted secondary document processing instruction.

### BACKGROUND OF THE INVENTION

The subject application is directed generally to document processing operations completed on a streaming data output. The application is particularly applicable to alteration of instructions in a document data stream to insert or substitute additional operations that may be desired.

Document processing devices, such as printers, copiers, scanners, facsimile machines or the like, typically receive electronic documents from other devices, such as networked workstations or other such devices, in a data stream. Such a data stream suitably occurs in a networked, dedicated or shared data connection which is suitably wired or wireless. By way of example, a device may include an application or printer driver which communicates an electronic document, such as a word processing document or image file, to an associated device such as a multifunction peripheral. The stream may include instructions, such as specifying output format, media, number of copies or finishing options for a document. Once such a stream is initiated and communicated, a document processing device will follow the instructions in the stream and process an electronic document accordingly

### SUMMARY OF THE INVENTION

In accordance with one embodiment of the subject application, there is provided a system and method for altering document output properties in accordance with altering intercepted print stream data. Print stream data is received from an associated data processing device, with the print stream including data corresponding to at least one electronic document and data corresponding to instructions for processing the one or more electronic documents. Data representing at least one preselected data string is then stored in a data storage, with the data string corresponding to a document processing command. Preferably, the data string is stored associatively with data corresponding to a secondary document processing instruction. The received print stream data is then compared to the at least one preselected data string, and a coincidence between the print stream data and the at least one preselected data string is then detected in accordance with an output of the comparison. The secondary document processing operation is then inserted into the print stream based upon a detected coincidence via the detection. Thereafter, a document processing operation is completed on the electronic document inclusive of the secondary document processing operation in accordance with an inserted secondary document processing instruction.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for altering document output properties in accordance with altering intercepted print stream data according to one embodiment of the subject application;

FIG. 2 is a block diagram illustrating device hardware for use in the system for altering document output properties in accordance with altering intercepted print stream data according to one embodiment of the subject application;

FIG. 3 is a functional diagram illustrating the device for use in the system for altering document output properties in accordance with altering intercepted print stream data according to one embodiment of the subject application;

FIG. 4 is a block diagram illustrating controller hardware for use in the system for altering document output properties in accordance with altering intercepted print stream data according to one embodiment of the subject application;

FIG. 5 is a functional diagram illustrating the controller for use in the system for altering document output properties in accordance with altering intercepted print stream data according to one embodiment of the subject application;

FIG. 6 is a functional diagram illustrating a workstation for use in the system for altering document output properties in accordance with altering intercepted print stream data according to one embodiment of the subject application;

FIG. 7 is a functional diagram illustrating a server for use in the system for altering document output properties in accordance with altering intercepted print stream data according to one embodiment of the subject application;

FIG. 8 is a block diagram illustrating the system for altering document output properties in accordance with altering intercepted print stream data according to one embodiment of the subject application;

FIG. 9 is a functional diagram illustrating the system for altering document output properties in accordance with altering intercepted print stream data according to one embodiment of the subject application;

FIG. 10 is a flowchart illustrating a method for altering document output properties in accordance with altering intercepted print stream data according to one embodiment of the subject application; and

FIG. 11 is a flowchart illustrating a method for altering document output properties in accordance with altering intercepted print stream data according to one embodiment of the subject application.

### DETAILED DESCRIPTION OF THE PREFERRED EMBODIMENT

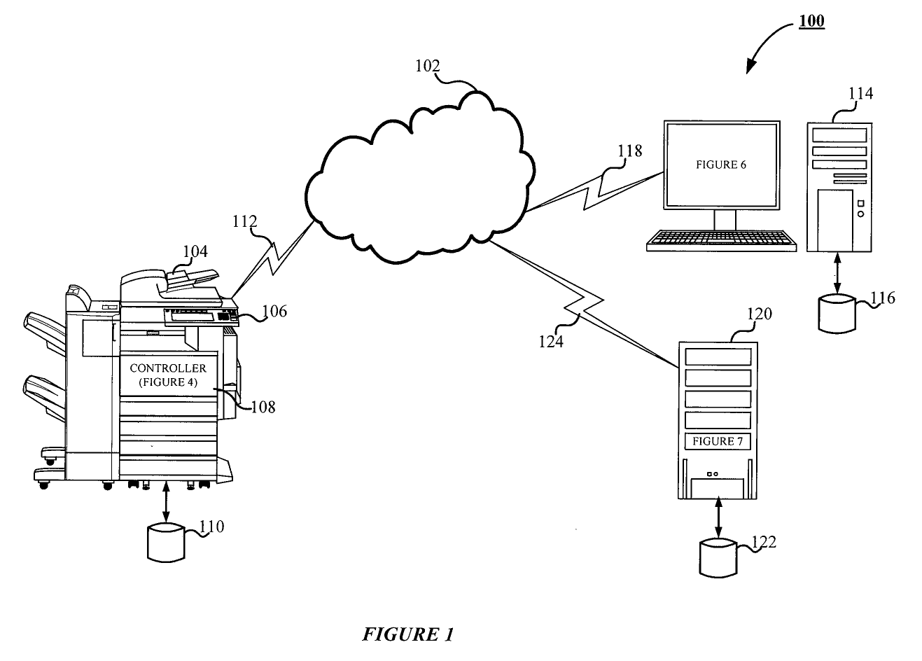

The subject application is directed to a system and method for document processing operations completed on a streaming data output. In particular, the subject application is directed to a system and method for use in the alteration of instructions in a document data stream to insert or substitute additional operations that may be desired. More particularly, the subject application is directed to a system and method that alters document output properties in accordance with altering intercepted print stream data. It will become apparent to those skilled in the art that the system and method described herein are suitably adapted to a plurality of varying electronic fields employing templates, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for altering document output properties in accordance with altering intercepted print stream data in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

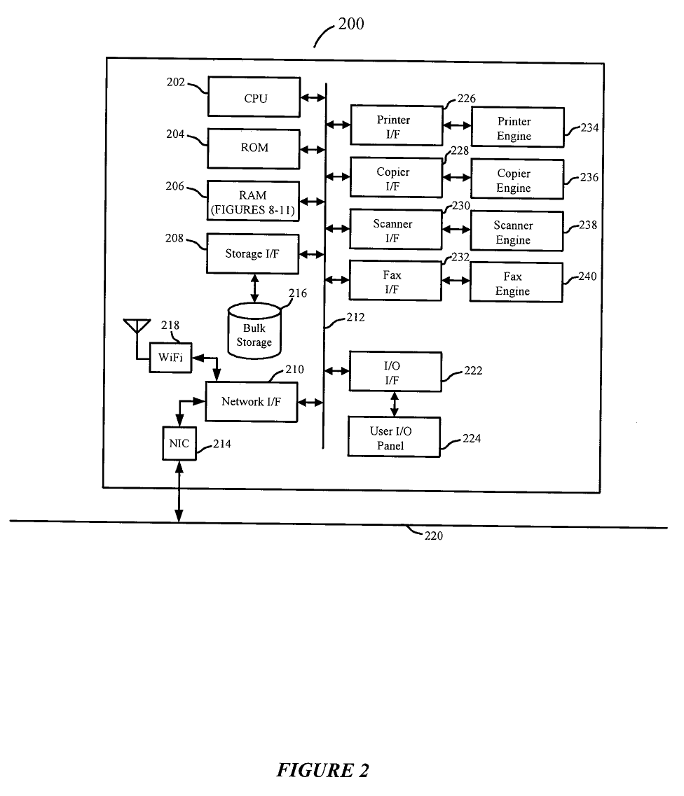

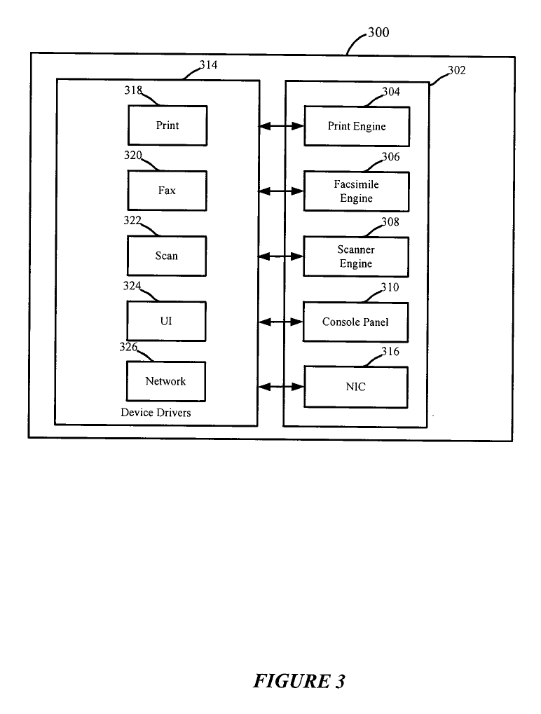

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

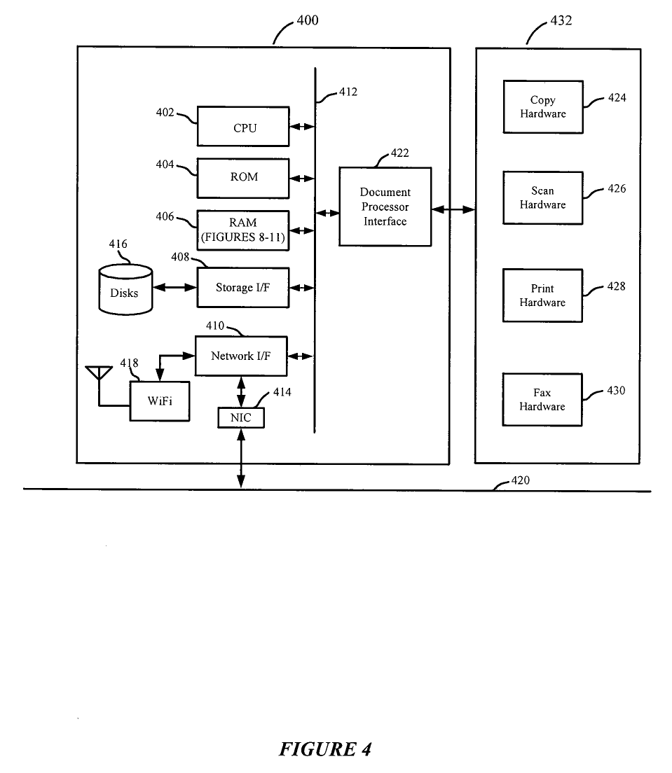

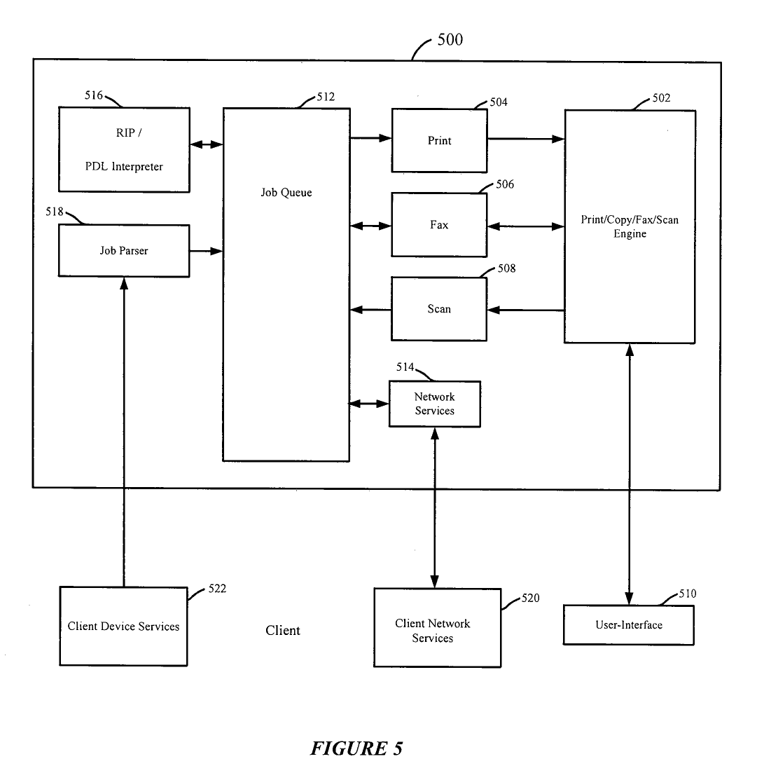

In accordance with one embodiment of the subject application, the document processing device 104 incorporates a backend component, designated as the controller 108, and suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for altering document output properties in accordance with altering intercepted print stream data of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, character set data, user-supplied data fields, modified image data, redacted data, user information, cellular telephone data, document processing instructions, graphical user interface data, customer information, workflow data, payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like.

Also depicted in FIG. 1 is a user device 114, illustrated as a computer workstation in data communication with the computer network 102 via a communications link 118. It will be appreciated by those skilled in the art that the user device 114 is shown in FIG. 1 as a workstation computer for illustration purposes only. As will be understood by those skilled in the art, the user device 114 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the user device 114 further includes software, hardware, or a suitable combination thereof configured to interact with the document processing device 104, or the like.

Communicatively coupled to the user device 114 is the data storage device 116. According to one example embodiment of the subject application, the data storage device 116 is any mass storage device, or plurality of such devices, known in the art including, for example and without limitation, magnetic storage drives, a hard disk drive, optical storage devices, flash memory devices, or any suitable combination thereof. In such an embodiment, the data storage device 116 is suitably adapted to store page job language data, printer control language data, page description language data, page display language filters, search patterns, preselected data strings, account information, template data, electronic document data, electronic form data, scanned electronic image data, and the like. It will be appreciated by those skilled in the art that while illustrated in FIG. 1 as being a separate component of the system 100, the data storage device 116 is capable of being implemented as an internal storage component of the user device 114, or the like, such as, for example and without limitation, an internal hard disk drive, or the like.

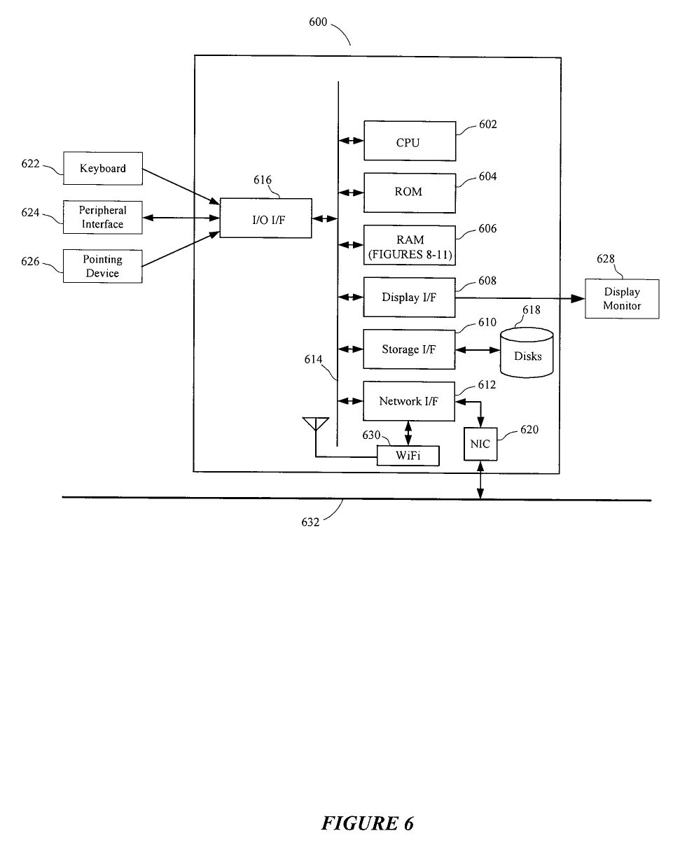

The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to provide document data, job data, filter functionality, user interface data, image data, monitor document processing jobs, employ thin-client interfaces, generate display data, generate output data, or the like, with respect to the document processing device 104, or any other similar device coupled to the computer network 102. The functioning of the user device 114 will better be understood in conjunction with the block diagram illustrated in FIG. 6, explained in greater detail below.

The system 100 illustrated in FIG. 1 further depicts a backend component, shown as the server 120, in data communication with the computer network 102 via a communications link 124. It will be appreciated by those skilled in the art that the server 120 is shown in FIG. 1 as a component of the system 100 for example purposes only, and the subject application is capable of implementation without the use of a separate backend server component, e.g. the server 120 is capable of implementation via the document processing device 104, or via the user device 114. The skilled artisan will appreciate that the server 120 comprises hardware, software, and combinations thereof suitably adapted to provide one or more services, web-based applications, storage options, and the like, to networked devices. In accordance with one example embodiment of the subject application, the server 120 includes various components, implemented as hardware, software, or a combination thereof, managing retention of print stream filters, managing retention of documents, text data, performing searches, comparisons, maintaining database entries, account information, receiving payment data, retrieval of documents, and the like, which are accessed via the computer network 102.

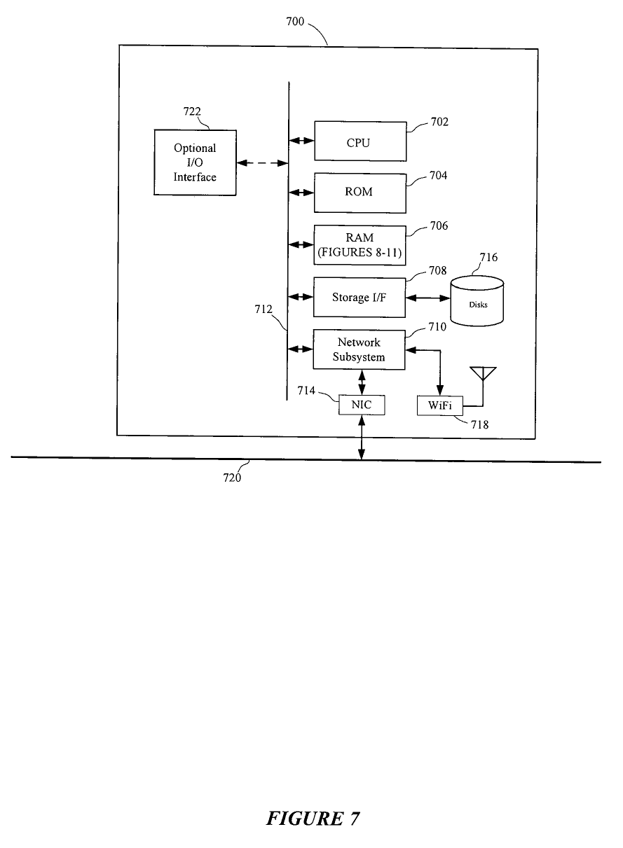

The communications link 124 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 120 are capable of implementation on any suitable computing device coupled to the computer network 102, e.g. the controller 108, or the like. The functioning of the server 120 will better be understood in conjunction with the block diagram illustrated in FIG. 7, explained in greater detail below.

Communicatively coupled to the server 120 is the data storage device 122. According to the foregoing example embodiment, the data storage device 122 is any mass storage device, or plurality of such devices, known in the art including, for example and without limitation, magnetic storage drives, a hard disk drive, optical storage devices, flash memory devices, or any suitable combination thereof. In such an embodiment, the data storage device 122 is suitably adapted to store print stream filters, page display language filters, search patterns, preselected data strings, user information, database information, a document management system data, electronic documents, tag data, positioning data, layout data, and the like. It will be appreciated by those skilled in the art that while illustrated in FIG. 1 as being a separate component of the system 100, the data storage device 122 is capable of being implemented as an internal storage component of the server 120, or the like, such as, for example and without limitation, an internal hard disk drive, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the user device 114, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

Turning now to FIG. 7, illustrated is a representative architecture of a suitable server 700 (depicted in FIG. 1 as the server 120), on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

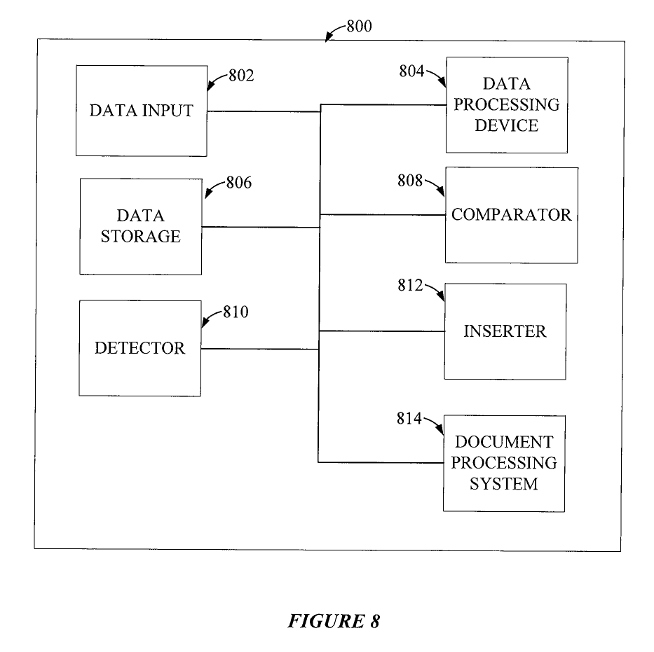

Referring now to FIG. 8, illustrated is a block diagram of a system 800 for altering document output properties in accordance with altering intercepted print stream data in accordance with one embodiment of the subject application. As shown in FIG. 8, the system 800 includes a data input 802 configured to receive print stream data from an associated data processing device 804. In accordance with one embodiment of the subject application, the print stream includes data corresponding to at least one electronic document and data corresponding to instructions for processing the at least one electronic document. The system 800 also includes a data storage 806 operable for storing data representing at least one preselected data string, with the data string corresponding to a document processing command. Preferably, the data string is stored associatively with data corresponding to a secondary document processing instruction.

Also included in the system 800 is a comparator 808, which is configured to compare received the print stream data to the at least one preselected data string. The system further incorporates a detector 810, which functions to detect coincidence between print stream data and the at least one preselected data string based upon the output of the comparator 808. An inserter 812 is also included so as to insert the secondary document processing instruction into the print stream data based upon any detected coincidence by the detector 810. The system also incorporates a document processing system 814 configured to complete a document processing operation on the electronic document, including the secondary document processing operation according to an inserted secondary document processing instruction.

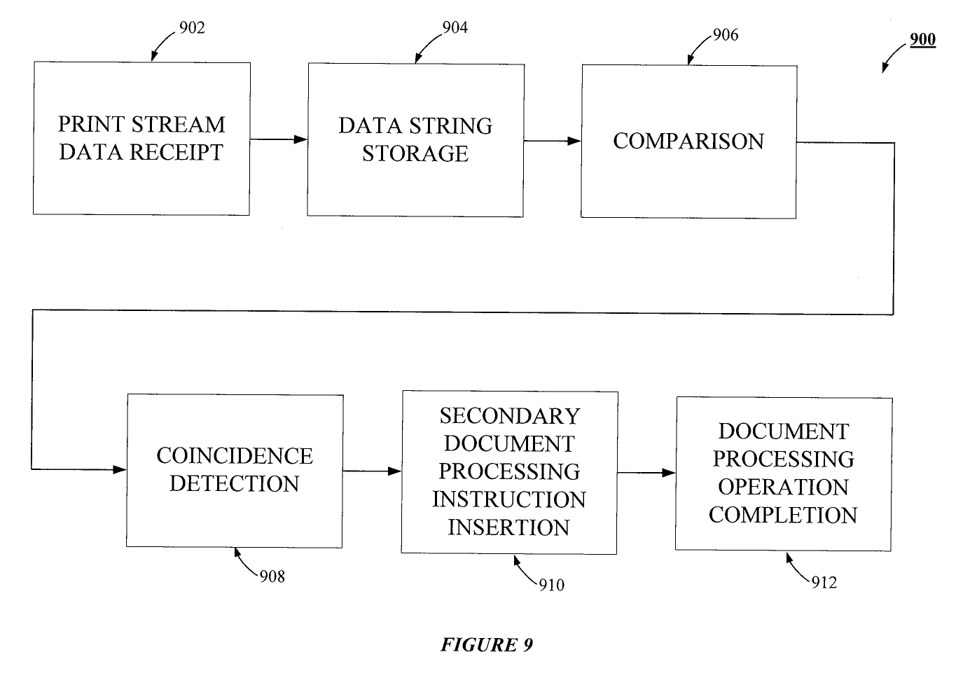

Turning now to FIG. 9, illustrated is a functional diagram of a system 900 for altering document output properties in accordance with altering intercepted print stream data in accordance with one embodiment of the subject application. As shown in FIG. 9, print stream data receipt 902 first occurs of print stream data from an associated data processing device. Preferably, the received print stream data includes data corresponding to at least one electronic document and data corresponding to instructions for processing any such electronic documents. Data string storage 904 is then performed in a data storage of data representing at least one preselected data string, with the data string corresponding to a document processing command. In accordance with one embodiment of the subject application, the data string is stored associatively with data corresponding to a secondary document processing instruction.

A comparison 906 is then performed between the received print stream data and the at least one preselected data string. Coincidence detection 908 then occurs between the print stream data and the at least one preselected data string based upon the output of the comparison 906. Secondary document processing operation instruction insertion 910 is then performed via the insertion of the secondary operation into the print stream data based upon a detected coincidence from the detection 908. Document processing operation completion 912 then occurs of the electronic document including the secondary document processing operation in accordance with an inserted secondary document processing instruction.

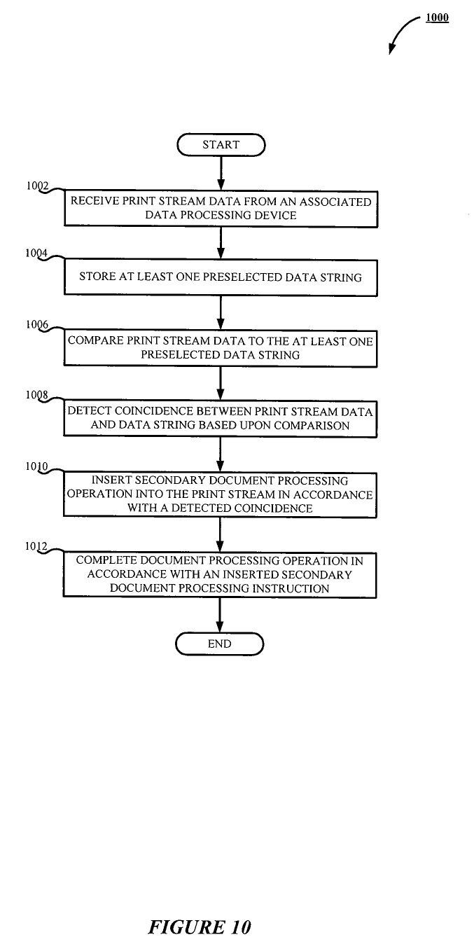

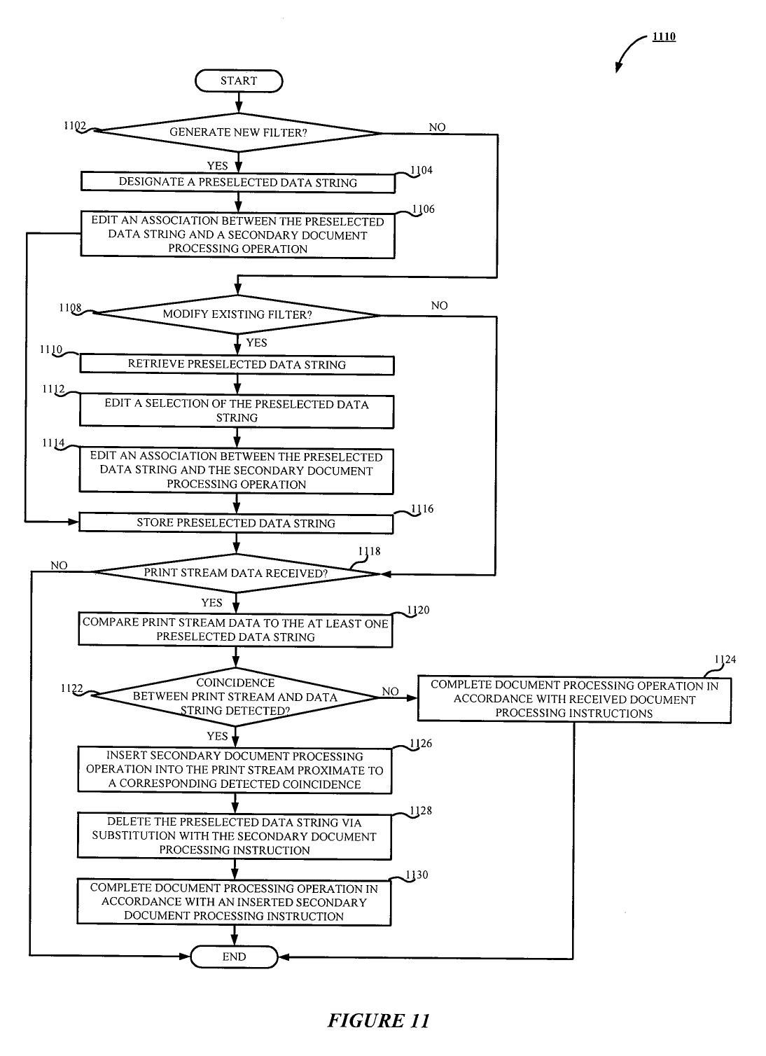

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11. Turning now to FIG. 10, there is shown a flowchart 1000 illustrating a method for altering document output properties in accordance with altering intercepted print stream data in accordance with one embodiment of the subject application. Beginning at step 1002, print stream data is received from an associated data processing device. According to one embodiment of the subject application, the print stream includes data corresponding to at least one electronic document and data corresponding to instructions for processing the one or more electronic documents.

At step 1004, data representing at least one preselected data string is stored in a data storage, with the data string corresponding to a document processing command. Preferably, the data string is stored associatively with data corresponding to a secondary document processing instruction. The received print stream data is then compared to the at least one preselected data string at step 1006. Coincidence between the print stream data and the at least one preselected data string is then detected at step 1008 in accordance with an output of the comparison performed at step 1006. The secondary document processing operation is then inserted into the print stream at step 1010 based upon a detected coincidence via the detection of step 1008. Thereafter, at step 1012, a document processing operation is completed on the electronic document inclusive of the secondary document processing operation in accordance with a secondary document processing instruction inserted via step 1010.

Referring now to FIG. 11, there is shown a flowchart 1100 illustrating a method for altering document output properties in accordance with altering intercepted print stream data in accordance with one embodiment of the subject application. The methodology of FIG. 11 begins at step 1102, whereupon a determination is made whether a new filter is to be generated for the document processing device 104. That is, whether a user associated with the user device 114 has initiated a web-based dialog so as to generate a new print stream filter. It will be appreciated by those skilled in the art that the generation of a new filter is capable of being accomplished via a web-based interface so as to create a new filter for storage on the server 120, the document processing device 104, the user device 114, or the like. In accordance with one embodiment of the subject application, a filter manager in association with a suitable data storage, e.g. the data storage 110, 116, or 122, facilitates the creation of a print stream filter via the web-based interface of the user device 114. Those skilled in the art will appreciate that any suitable web-based interface is capable of being employed to facilitate user interactions with print stream filtering according to the subject application. Upon a negative determination at step 1102, flow proceeds to step 1108, as discussed in greater detail below.

When it is determined at step 1102 that a new filter is to be generated, operations proceed to step 1104. At step 1104, the user, via the web-based user interface, designates a preselected data string. According to one embodiment of the subject application, the preselected data string corresponds to a search pattern for a filter, i.e. a preselected string of data within a print data stream including wildcard characters, escape sequences, output options, processing operations, processing instructions, and the like. After selection of a data string, operations proceed to step 1106, whereupon an association between the preselected data string and at least one secondary document processing operation is edited by the user. That is, the user selects a replacement pattern to overwrite or supersede the preselected search pattern. For example, when the preselected data string corresponds to an output on letter size paper, a suitable secondary operation may be to output a document instead on A4 size paper. The skilled artisan will appreciate that other such searches/replacements are also capable of implementation in accordance with the methodology of the subject application. Operations then proceed to step 1116, whereupon the newly generated filter, inclusive of the secondary document processing operation, is stored in a filter repository on a suitable storage device, e.g. the data storage device 110 of the document processing device 104, the data storage device 116 of the user device 114, the data storage device 122 of the server 120, or the like.

Returning to step 1102, when it is determined that a new filter is not to be generated, operations progress to step 1108. At step 1108, a determination is made whether an existing filter is to be modified. That is, whether the user associated with the web-based user interface of the user device 114 has selected an existing filter for modification. Upon a negative determination, operations proceed to step 1118, which is discussed in greater detail below. Following a positive determination at step 1108, flow proceeds to step 1110, whereupon preselected data strings are retrieved from the filter repository for modification at the user device 114. The skilled artisan will appreciate that the modification of such a filter is capable of being accomplished via any suitable computing device, e.g. the document processing device 104 or the server 120 of FIG. 1, capable of implementing the web-based user interface.

At step 1112, a selection of the preselected data strings is edited via the web user interface by the associated user via the user device 114, the user interface 106, a suitable user input associated with the server 120, or the like. At step 1114, an associated between the preselected data string and the secondary document processing operation is edited by the user. The preselected data string is then stored in association with the secondary document processing operation on a suitable data storage device 110, 116, or 122 at step 1116.

A determination is then made at step 1118 whether print stream data from the user device 114 or other associated data processing device has been received. It will be appreciated by those skilled in the art that the print stream includes data corresponding to at least one electronic document and data corresponding to instructions for processing the electronic document. The skilled artisan will further appreciate that such a determination is capable of being accomplished via the controller 108, the user device 114, or the server 120, depending upon how the network 102 is configured with respect to document processing operations, i.e. whether document processing is performed partially at the user device 114, jobs are processed through the server 120, or directly by the document processing device 104. For example purposes only, reference is made hereinafter to the controller 108 associated with the document processing device 104 performing steps 1118 through 1130, although the skilled artisan will appreciate that any suitable device in data communication with the document processing device 104 and filter repository is also capable of performing these steps. In the event that no print stream data has been received by the controller 108 at step 1118, operations with respect to FIG. 11 terminate.

After a determination at step 1118 that print stream data has been received, flow proceeds to step 1120. At step 1120, the print stream data is compared to the preselected data strings in the filter repository. That is, the print stream data is filtered by the controller 108 using the search patterns of the various filters stored on the data storage device 110. A determination is then made at step 1122 whether a coincidence between the print stream data and at least one preselected data string has been detected. That is, a determination is made by the controller 108 whether a search pattern in the print stream data has been identified. When no such coincidence is detected, flow proceeds to step 1124. At step 1124, the controller 108 directs completion of the document processing operation based upon the original received document processing instructions by the document processing device 104, whereafter operations of FIG. 11 terminate.

When a coincidence is detected by the controller 108 at step 1122, operations proceed to step 1126, whereupon the secondary document processing operations associated with the detected preselected data string are inserted into the print stream data proximate to the detected coincidence. At step 1128, the preselected data string in the print stream data is deleted so as to substitute that data string with the secondary document processing instruction/operation. Stated another way, following detection of the preselected data string in the print stream, the controller 108 substitutes the secondary operation for the preselected data string proximately in the print stream data thereby removing the preselected data string from the print stream, e.g. a find and replace operation. Thereafter, flow proceeds to step 1130, whereupon the document processing operation is completed by the document processing device 104 in accordance with the inserted secondary document processing operation/instruction.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for altering document output properties in accordance with altering intercepted print stream data comprising:
a data input operable to receive print stream data from an associated data processing device, the print stream including data corresponding to at least one electronic document and data corresponding to instructions for processing thereof;
a data storage operable for storing data representative of at least one preselected data string, the data string corresponding to a document processing command, which data string is stored associatively with data corresponding to a secondary document processing instruction;
a comparator operable to compare received print stream data to the at least one preselected data string;
a detector operable to detect coincidence between print stream data and the at least one preselected data string in accordance with an output of the comparator;
an inserter operable to insert the secondary document processing instruction into the print stream data in accordance with a detected coincidence by the detector; and
a document processing system operable to complete a document processing operation on the electronic document inclusive of the secondary document processing operation in accordance with an inserted secondary document processing instruction.

2. The system of claim 1 wherein the inserter is further operable to insert the secondary document processing instruction into the print stream proximate to a corresponding detected coincidence.

3. The system of claim 2 wherein the inserter is further operable to delete the at least one preselected data string such that the secondary document processing instruction is substituted therefore.

4. The system of claim 1 further comprising an editor operable to edit a selection of the at least one preselected data string.

5. The system of claim 4 wherein the editor is further operable to edit an association between the at least one preselected data string and the secondary document processing instruction.

6. The system of claim 1 wherein the data stream is comprised of a page display language.

7. The system of claim 5 wherein the editor is comprised of a web user interface.

8. A method of altering document output properties in accordance with altering intercepted print stream data comprising the steps of:
receiving print stream data from an associated data processing device, the print stream including data corresponding to at least one electronic document and data corresponding to instructions for processing thereof;
storing, in a data storage, data representative of at least one preselected data string, the data string corresponding to a document processing command, which data string is stored associatively with data corresponding to a secondary document processing instruction;
comparing received print stream data to the at least one preselected data string;
detecting coincidence between print stream data and the at least one preselected data string in accordance with an output of the comparing;
inserting the secondary document processing operation into the print stream data in accordance with a detected coincidence by the detecting; and
completing a document processing operation on the electronic document inclusive of the secondary document processing operation in accordance with an inserted secondary document processing instruction.

9. The method of claim 8 further comprising the step of inserting the secondary document processing instruction into the print stream proximate to a corresponding detected coincidence.

10. The method of claim 9 further comprising the step of deleting the at least preselected one data string such that the secondary document processing instruction is substituted therefore.

11. The method of claim 8 further comprising the step of editing a selection of the at least one preselected data string.

12. The method of claim 11 further comprising the step of editing an association between the at least one preselected data string and the secondary document processing operation.

13. The method of claim 8 wherein the data stream is comprised of a page display language.

14. The method of claim 12 wherein the editor is comprised of a web user interface.

15. A system of altering document output properties in accordance with altering intercepted print stream data comprising:
means adapted for receiving print stream data from an associated data processing device, the print stream including data corresponding to at least one electronic document and data corresponding to instructions for processing thereof;
means adapted for storing, in a data storage, data representative of at least one preselected data string, the data string corresponding to a document processing command, which data string is stored associatively with data corresponding to a secondary document processing instruction;
means adapted for comparing received print stream data to the at least one preselected data string;
means adapted for detecting coincidence between print stream data and the at least one preselected data string in accordance with an output of the comparing means;
means adapted for inserting the secondary document processing operation into the print stream data in accordance with a detected coincidence by the detecting means; and
means adapted for completing a document processing operation on the electronic document inclusive of the secondary document processing operation in accordance with an inserted secondary document processing instruction.

16. The system of claim 15 further comprising means adapted for inserting the secondary document processing instruction into the print stream proximate to a corresponding detected coincidence.

17. The system of claim 17 further comprising means adapted for deleting the at least preselected one data string such that the secondary document processing instruction is substituted therefore.

18. The system of claim 15 further comprising means adapted for editing a selection of the at least one preselected data string.

19. The system of claim 18 further comprising means adapted for editing an association between the at least one preselected data string and the secondary document processing operation.

20. The system of claim 15 wherein the data stream is comprised of a page display language.
